(19) United States
(12) Patent Application Publication
(10) Pub. No.: US 2013/0202108 A1
(43) Pub. Date: Aug. 8, 2013

(54) METHOD AND DEVICE FOR GENERATION OF SECRET KEY

(71) Applicants: Shih-Wei KAO, Hsinchu City (TW); Tien-Yen MA, New Taipei City (TW)

(72) Inventors: Shih-Wei KAO, Hsinchu City (TW); Tien-Yen MA, New Taipei City (TW)

(21) Appl. No.: 13/595,867

(22) Filed: Aug. 27, 2012

(30) Foreign Application Priority Data
Feb. 7, 2012 (TW) 101103850

(51) Int. Cl. H04L 9/00

(52) U.S. Cl. 380/44

(57) ABSTRACT

A method and a device for generation of a secret key are provided. In one exemplary embodiment, the disclosure is directed to a device for generation of a secret key. The device for generation of a secret key includes a motion sensor, a storage unit and a control unit. The motion sensor is configured to sense a motion of the device in a three-dimensional space and generate a motion sensing signal. The storage unit is configured to store the motion sensing signal. The control unit is electrically coupled to the motion sensor and the storage unit, and configured to generate a secret key by the motion sensing signal.

### CROSS REFERENCE TO RELATED APPLICATIONS

The present application is based on, and claims priority from, Taiwan (International) Application Serial Number 101103850, filed on Feb. 7, 2012, the disclosure of which is hereby incorporated by reference herein in its entirety.

### BACKGROUND

Miniaturization based on Micro Electro Mechanical Systems (MEMS) technology has been achieved for mechanical devices. Especially, miniaturization of an inertial measurement unit (IMU), which has a large volume and is too expensive. The popularity growth rate of smart handheld devices is high. An MEMS accelerometer, is the currently most used MEMS device in smart handheld devices. In 2010, the usage of the MEMS gyroscope increased with the introduction of the Apple iPhone 4 equip with the MEMS gyroscope. Thereafter, other mobile phone manufacturers (e.g., Samsung) also equip their smart handheld devices with MEMS gyroscopes. Because the MEMS gyroscope and new high-speed microprocessors are a part of the smart handheld devices, hardware for executing inertial navigation systems (INS) have been around for a while now. But, manufacturers normally choose cheaper MEMS devices to be used in the smart handheld devices in order to control costs. When the smart handheld devices execute the inertial navigation system, noise and error will seriously cause track drift when an electronic signal is transferred to a motion.

Therefore, another method and device for generation of a secret key is provided. The method and device for generation of a secret key can transfer the motion features to a secret key, and also can avoid the noise interference from an environment and improve the recognition rate of signals.

### SUMMARY

A detailed description is given in the following embodiments with reference to the accompanying drawings.

Methods and devices for generation of a secret key are provided.

In one exemplary embodiment, the disclosure is directed to a device for generation of a secret key. The device for generation of a secret key comprises a motion sensor, a storage unit and a control unit. The motion sensor is configured to sense a motion of the device in a three-dimensional space and generate a motion sensing signal. The storage unit is configured to store the motion sensing signal. The control unit is electrically coupled to the motion sensor and the storage unit, and configured to generate a secret key by the motion sensing signal.

In one exemplary embodiment, the disclosure is directed to a method for generation of a secret key. The method comprises: sensing, by a motion sensor, a motion of a device in a three-dimensional space and generating a motion sensing signal; storing, by a storage unit, the motion sensing signal; and generating, by a control unit, a secret key by transferring the motion sensing signal.

### DRAWINGS

The present disclosure can be more fully understood by reading the subsequent detailed description and examples with references made to the accompanying drawings, wherein:

FIG. 1A is an architecture diagram of a device for generation of a secret key according to an embodiment of the present disclosure;

FIG. 1B is a flow diagram illustrating the method for generation of a secret key according to an embodiment of the present disclosure;

FIG. 2 is a schematic diagram illustrating the device for generation of a secret key transmitting a secret key according to an embodiment of the present disclosure;

FIG. 3 is an architecture diagram of the motion sensor according to an embodiment of the present disclosure;

FIG. 4 is a schematic diagram for explaining the operation of the motion sensor according to an embodiment of the present disclosure;

FIG. 5 is an architecture diagram of the storage unit according to an embodiment of the present disclosure;

FIG. 6 is a flow chart illustrating the device for generation of a secret key sensing the motion according to an embodiment of the present disclosure;

FIG. 7 is a flow chart illustrating the device for generation of a secret key generating the secret key according to an embodiment of the present disclosure;

FIG. 8 is a motion schematic diagram according to an embodiment of the present disclosure;

FIG. 9 is a schematic diagram illustrating how the random seed is generated according to an embodiment of the present disclosure;

FIG. 10 is a motion schematic diagram according to another embodiment of the present disclosure;

FIG. 11 is a schematic diagram illustrating how the random seed is generated according to another embodiment of the present disclosure;

FIG. 12 is a schematic diagram illustrating the random seed generating an asymmetric key pair according to an embodiment of the present disclosure; and

FIG. 13 is a schematic diagram illustrating how the secret key is used according to an embodiment of the present disclosure.

### DETAILED DESCRIPTION

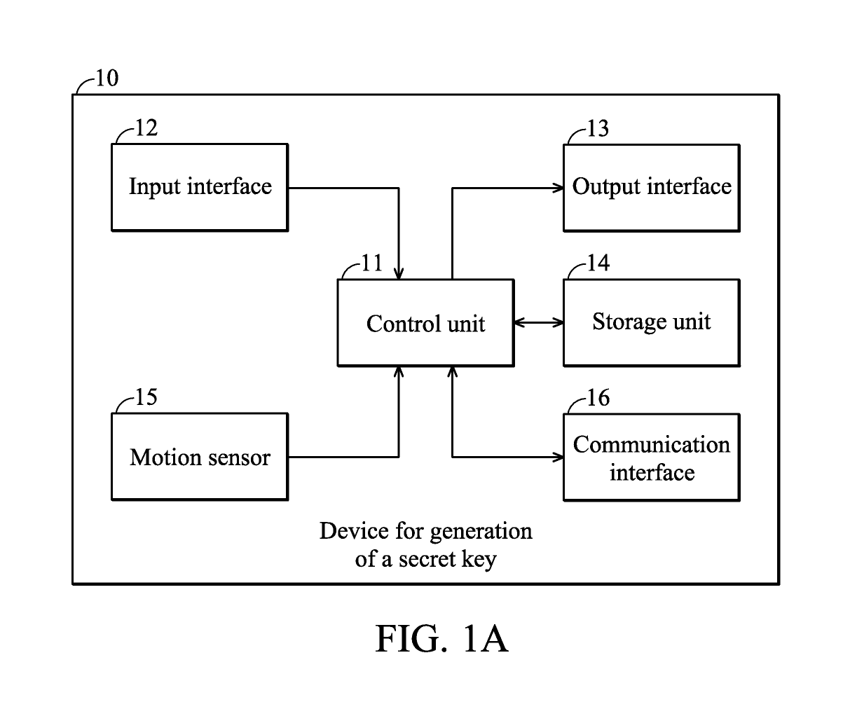

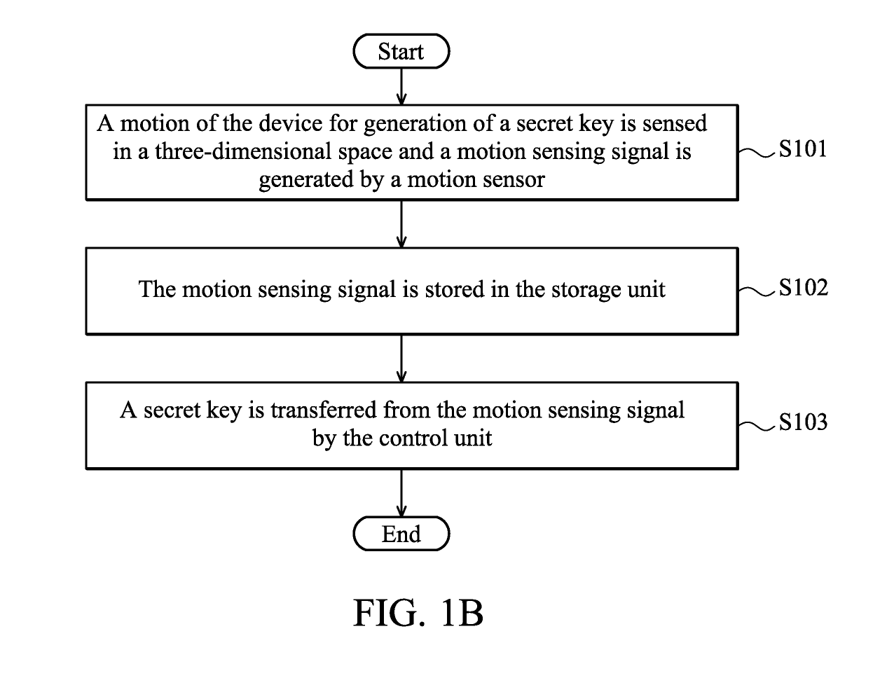

Several exemplary embodiments of the application are described with reference to FIGS. 1A through 13, which generally relate to generation of a secret key. It is to be understood that the following disclosure provides various different embodiments as examples for implementing different features of the application. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 1A is an architecture diagram of a device 10 for generation of a secret key according to an embodiment of the present disclosure. As shown in FIG. 1A, the device 10 for generation of a secret key comprises a control unit 11, an input interface 12, an output interface 13, a storage unit 14, a motion sensor 15 and a communication interface 16. The control unit 11 is electrically coupled to the input interface 12, the output interface 13, the storage unit 14, the motion sensor 15 and the communication interface 16, respectively. The control unit 11 is, for example, a central processing hub, configured to communicate and interact between other units and generate a secret key. The input interface 12 is configured to receive an instruction inputted by a user to start or stop sensing the motion of the device 10 for generation of a secret key by the motion sensor 15. The storage unit 14 is configured to store the secret key and the information related to the secret key. The motion sensor 15 senses a motion of the device 10 for generation of a secret key in a three-dimensional space, generates a motion sensing signal and stores the motion sensing signal in the storage unit 14 through the control unit 11. The output interface 13 may display the current operational status information of the device 10 to the user for generation of a secret key, or output of the secret key generated by the control unit 11. The communication interface 16 may transmit the secret key generated by the device 10 for generation of a secret key to a remote device in a safe manner. When the user holds the device 10 for generation of a secret key and starts to sense a motion, the motion sensor 15 can detect a motion of the device 10 for generation of a secret key in a three-dimensional space and generate a motion sensing signal. Then, the control unit 11 stores the motion sensing signal in the storage unit 14. After the user inputs a stop signal through the input interface 12, the motion sensor 15 stops sensing the motion. The control unit 11 then uses the motion sensing information and the information related to generate the secret key stored in the storage unit 14, and generates the secret key after appropriate signal processing and logic operations, and stores the secret key in the storage unit 14. The control unit 11 can access the secret key according to needs of the user or transmit the secret key to the remote device through the communication interface 16.

In this embodiment, the device 10 for generation of a secret key can be a handheld mobile device, for example, a mobile phone, a digital player, a personal digital assistant (PDA) and so on.

FIG. 1B is a flow diagram illustrating the method for generation of a secret key according to an embodiment of the present disclosure with reference to FIG. 1A. First, in step S101, a motion of a device for generation of a secret key is sensed in a three-dimensional space and a motion sensing signal is generated by a motion sensor. Then, in step S102, the motion sensing signal is stored in the storage unit. Finally, in step S103, a secret key is transferred from the motion sensing signal by the control unit.

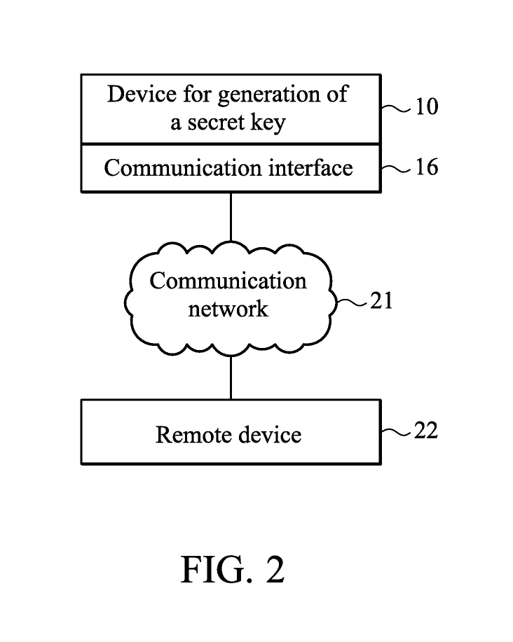

FIG. 2 is a schematic diagram illustrating the device for generation of a secret key transmitting a secret key according to an embodiment of the present disclosure. Referring to FIG. 2 and FIG. 1A, in the embodiment, the device 10 for generation of a secret key transmits the secret key to a remote device 22 by using the communication interface 16 through the communication network 21. The communication network 21 can use a variety of wired or wireless communications technology, which includes but are not limited to a universal serial bus (USB), a local area network (LAN), a wireless local area network (WLAN) or a Bluetooth, and so on.

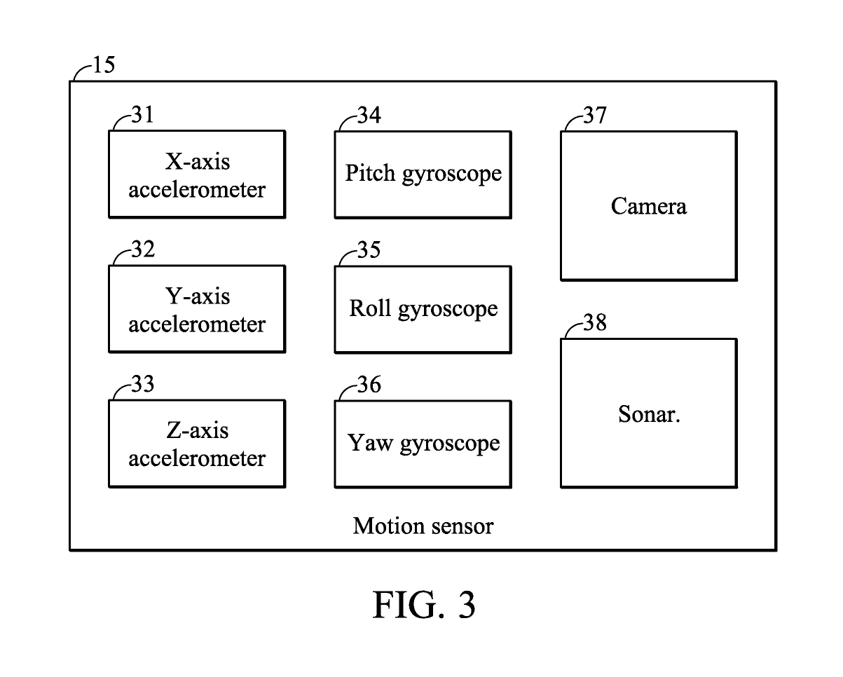

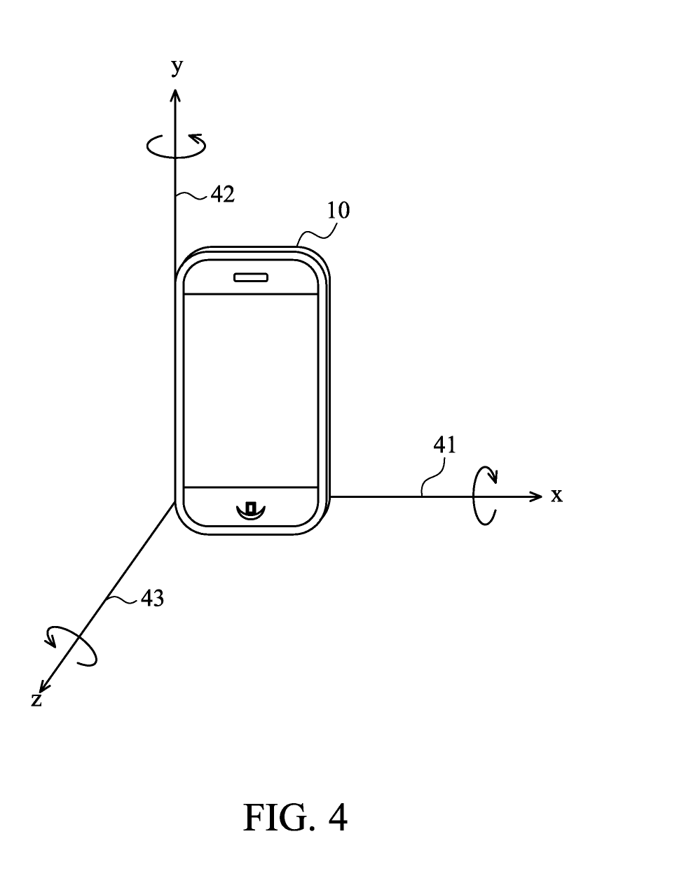

FIG. 3 is an architecture diagram of the motion sensor 15 according to an embodiment of the present disclosure. FIG. 4 is a schematic diagram for explaining the operation of the motion sensor 15 according to an embodiment of the present disclosure. As shown in FIG. 3 and FIG. 4, the motion sensor comprises an X-axis accelerometer 31, a Y-axis accelerometer 32, a Z-axis accelerometer 33, a pitch gyroscope 34, a roll gyroscope 35, a yaw gyroscope 36, a camera 37 and a sonar 38. The X-axis accelerometer 31, the Y-axis accelerometer 32 and the Z-axis accelerometer 33 are configured to measure an X-axis acceleration, a Y-axis acceleration and a Z-axis acceleration of the device 10 for generation of a secret key along the X-axis 41, the Y-axis 42, and the Z-axis 43 in the three-dimensional Cartesian coordinates, respectively. The pitch gyroscope 34, the roll gyroscope 35 and the yaw gyroscope 36 are configured to measure a pitch angular velocity, a roll angular velocity, and a yaw angular velocity of the device 10 for generation of a secret key along the X-axis 41, the Y-axis 42 and the Z-axis in the three-dimensional Cartesian coordinates. In one embodiment, the motion sensor can comprise the camera 37. The camera 37 measures a relative motion between the device 10 for generation of a secret key and surrounding objects or reference images by using an optical manner. Specifically, but not limited to such examples, the camera 37 can use a normal optical camera or a depth camera and the like. In another embodiment, the motion sensor can further comprise the sonar 38. The sonar 38 can use an acoustic signal to measure a relative motion between the device 10 for generation of a secret key and surrounding objects or reference images. More specifically, but not limited to such examples, the sonar 38 can use a normal sonar or an ultrasound technology.

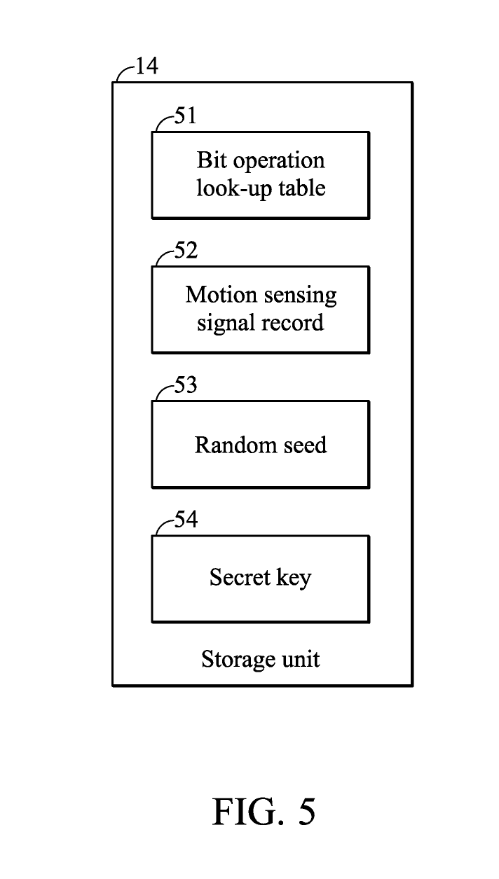

FIG. 5 is an architecture diagram of the storage unit 14 according to an embodiment of the present disclosure. As shown in FIG. 5, the storage unit 14 stores a bit operation look-up table 51, a motion sensing signal record 52, a random seed 53 and a secret key 54. The operation look-up table 51 records the relative relationship between the features of the motions along each axis sensed by the motion sensor 15 and the operations for generating the random seeds. The motion sensor signal record 52 stores the motion sensing signal of N degrees of freedom which is generated by the motion sensor 15, wherein N is a natural number which is greater than or equal to 1 and smaller than or equal to 6. The random seed 53 stores an unfixed-length bit stream calculated by the control unit 11 according to the operation look-up table 51 and the motion sensor signal record 52. The secret key 54 is a specific-length bit stream calculated by the control unit 11 according to the random seed 53.

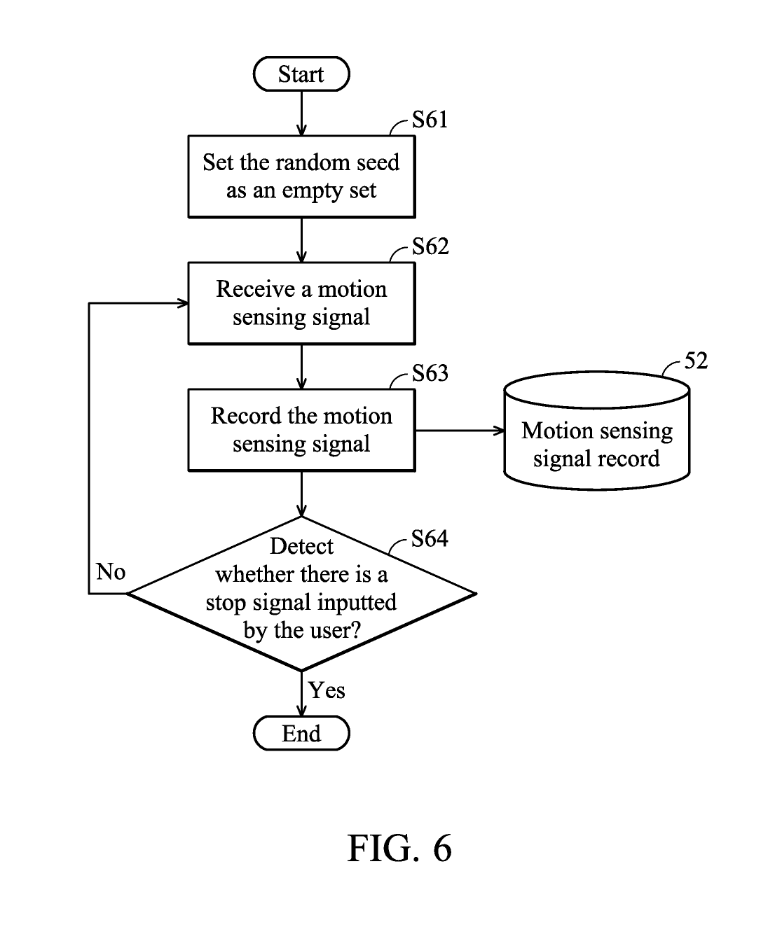

FIG. 6 is a flow chart illustrating the device 10 for generation of a secret key sensing the motion according to an embodiment of the present disclosure with reference to FIG. 1A and FIG. 5. First of all, the device 10 for generation of a secret key starts to sense a motion. The control unit 11 starts the motion sensor 15 to sense the motion. In step S61, the control unit 11 sets the random seed 53 stored in the storage unit 14 as an empty set. Then, in step S62, the control unit 11 receives a motion sensing signal from the motion sensor 15. In step S63, after receiving the motion sensing signal, the control unit 15 records and stores the motion sensing signal in the motion sensor signal record 52 which is in the storage unit 14. Finally, in step S64, the control unit 11 detects whether there is a stop signal inputted by the user through the input interface 12. When the control unit 11 detects the stop signal (“Yes” in step S64), the control unit 11 stops detecting the motion sensing signal. When the control unit 11 does not detect the stop signal (“No” in step S64), the step S63 is performed to repeat the previously mentioned steps.

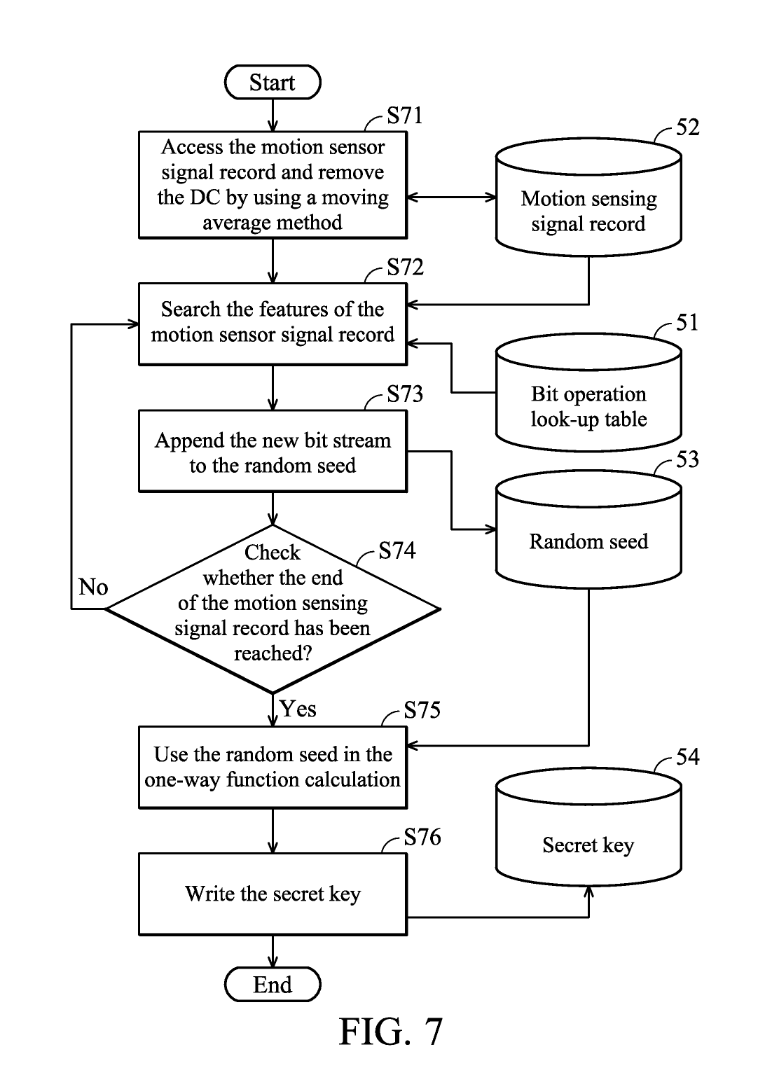

FIG. 7 is a flow chart illustrating the device 10 for generation of a secret key generating the secret key according to an embodiment of the present disclosure with reference to FIG. 1A and FIG. 5. First of all, the control unit 11 starts to perform the generation of a secret key. The control unit 11 preprocesses the curve of the motion sensor signal record. In step S71, the control unit 11 accesses the motion sensor signal record 52 stored in the storage unit 14, and removes the DC by using a moving average method. Then, the control unit 11 further removes the high frequency noise of the motion sensing signal by using the curve smoother method. In the embodiment, a person skilled in the art should be able to understand that the curve smoother algorithm can comprise a moving average method, a weighted moving average method and a least squares method (least squares) or a Bézier curve method, and so on. However, in addition to the above curve smoother algorithms, a person skilled in the art should be able to understand that other curve smoother algorithms can be used to remove the high frequency noise of the motion sensing signal. Then, in step S72, the control unit 11 searches the features of the motion sensor signal record. The control unit 11 searches the features according to the features of the motion sensor signal record recorded in the operation look-up table 51 and the search priority from a start time point when the motion sensor starts to sense the motion to a later time point. When the control unit 11 finds the feature which conform the feature of the motion sensor signal record, the control unit 11 triggers an operation event. The control unit 11 generates a new bit stream according to the operations defined in the operation look-up table 51. In addition, when the control unit 11 determines that there is more than one feature which can trigger a new operation event in the records sensed by the different sensors at the same time point, the control unit 11 adds the operation results to the new bit stream in accordance with the search priority. In step S73, the control unit 11 appends the new bit stream generated in step S72 to the random seed 53 stored in the storage unit 14. In step S74, the control unit 11 checks whether the end of the motion sensing signal record 52 has been reached. When the end of the motion sensing signal record 52 has not been reached (“No” in step S74), step S72 is performed and the control unit 11 continues to search the features of the motion sensing signal record 52. When the end of the motion sensing signal record 52 has been reached (“Yes” in step S74), in step S75, the control unit 11 uses the random seed 53 in the one-way function calculation, and generates a specific-length secret key. Finally, in step S76, the control unit 11 writes the secret key generated in the step S75 into the secret key 54 which is in the storage unit 14. Next, the control unit 11 ends the generation of the secret key, and outputs a signal to inform the user that the secret key has been generated completely through the output interface 13.

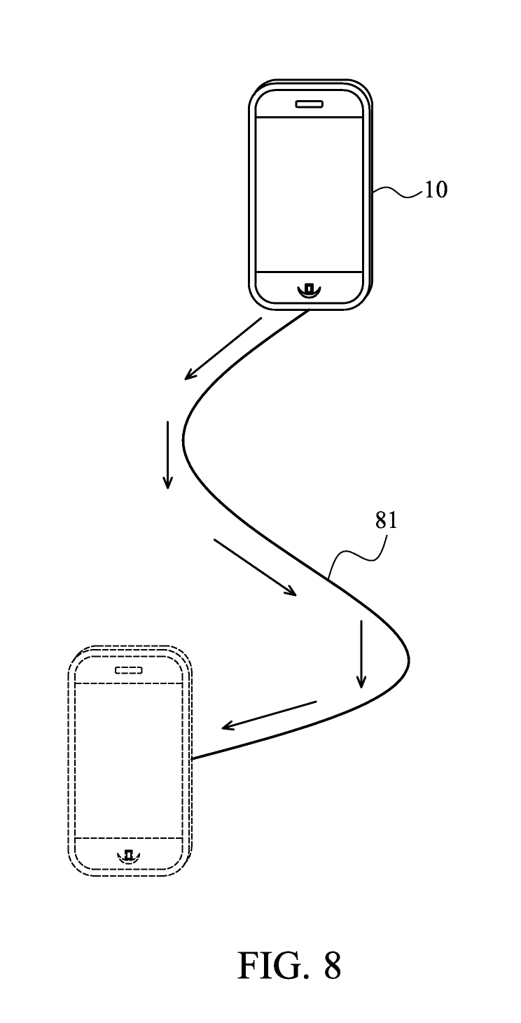

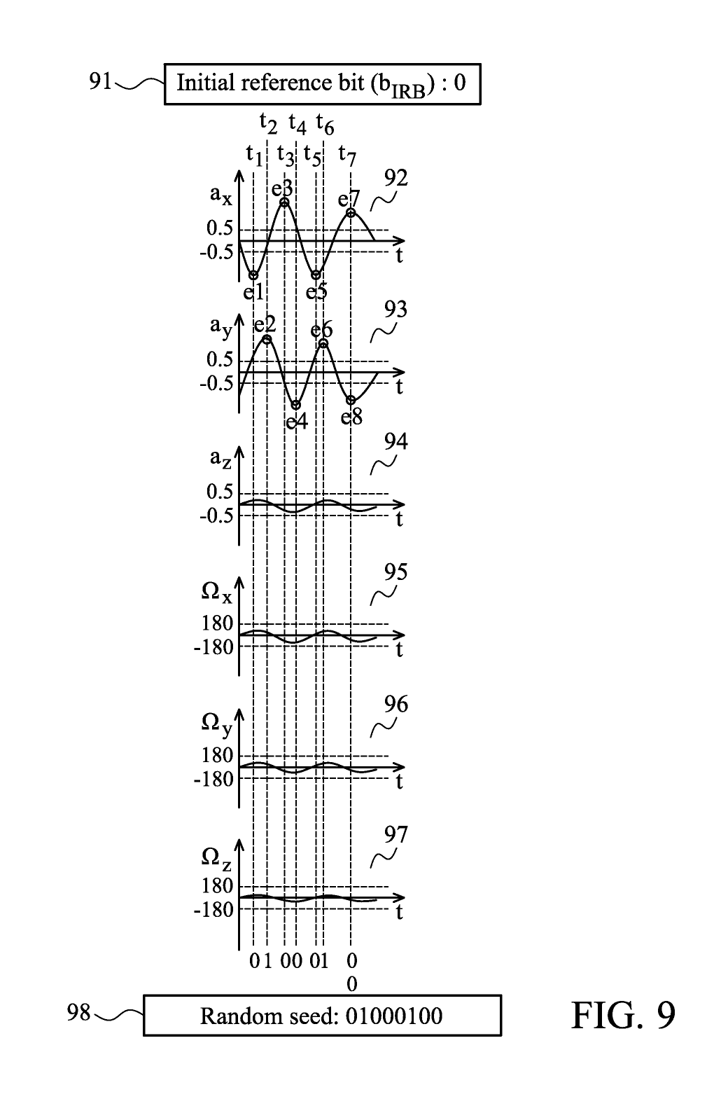

FIG. 8 is a motion schematic diagram according to an embodiment of the present disclosure. FIG. 9 is a schematic diagram illustrating how the random seed is generated according to an embodiment of the present disclosure. As shown in FIG. 8 and FIG. 9, the user holds the device 10 for generation of a secret key and senses the motion, wherein the track 81 of the motion is similar to an S-shaped curve, and the curve diagrams 92˜97 are the diagrams after the control unit 11 preprocesses the curve of the motion sensor signal record. Specifically, but not limited to such examples, Table 1 shows a bit operation look-up table.

TABLE 1

| | Input | | | Event | Opera- |
|---|---|---|---|---|---|
| Priority | axis | Unit | Event threshold | (Slope) | tion |
| 1 | aₓ | g | ±0.5 | Positive → 0 | [symbol] bᵢ₋₁ |
| | | | | Negative → 0 | bᵢ₋₁ |
| 2 | a_{y} | g | ±0.5 | Positive → 0 | [symbol] bᵢ₋₁ |
| | | | | Negative → 0 | bᵢ₋₁ |
| 3 | a_{z} | g | ±0.5 | Positive → 0 | [symbol] bᵢ₋₁ |
| | | | | Negative → 0 | bᵢ₋₁ |
| 4 | Ωₓ | deg/s | ±0.5 | Positive → 0 | [symbol] bᵢ₋₁ |
| | | | | Negative → 0 | bᵢ₋₁ |
| 5 | Ω_{y} | deg/s | ±0.5 | Positive → 0 | [symbol] bᵢ₋₁ |
| | | | | Negative → 0 | bᵢ₋₁ |
| 6 | Ω_{z} | deg/s | ±0.5 | Positive → 0 | [symbol] bᵢ₋₁ |
| | | | | Negative → 0 | bᵢ₋₁ |

As shown in Table 1, the priority, the input axis, the unit, the event threshold, the event, and the operation are defined in the bit operation look-up table. FIG. 9 shows that the events e₁˜e₈ are triggered during the time points t₁˜t₇ according to the Table 1. The random seed (b₀·b₇:01000100) 98 is generated according to the operation in Table 1 and an initial reference bit (b_{IRB}=0) 91. For example, the X-axis acceleration slope of the event e₁ changes from negative to 0 (Negative→0). The operation of b₀ is equal to the last bit (bᵢ₋₁) according to the operation in Table 1. Because there is no information before the bit b₀, the initial reference bit (b_{RB}=0) 91 is used to generate b₀=0. The rest bits b₁˜b₇ may be deduced by analogy. It is noteworthy that the events e₇ and e₈ occurred at the same time point t₇. Therefore, according to the priority defined in Table 1, the event e₇ generated by the X-axis acceleration curve has to be calculated first, and then the event e₈ generated by the Y-axis acceleration curve is calculated. Finally, b₆ and b₇ are generated in this order.

Table 1 is a bit operation look-up table according to a preferred embodiment of the present disclosure. The fields of Table 1 are the priority, the input axis, the unit, the event threshold, the event and the operation. The priority represents an order of priority for generating the bits of the random seed when the events of different axes are triggered at the same time. The input axis represents the type of the input axis. For example, aₓ represents the translation acceleration along the X-axis, and Ωₓ represents the rotation angular velocity along the Y-axis. The unit represents the unit of the sensing value. For example, the sensing value unit of the accelerometer can use the gravitational acceleration constant “g”, meters per second per second (m/s²), or other acceleration units. For another example, the sensing value unit of the gyroscope can use degrees per second (degree/s) or other angular velocity units. The event threshold represents the threshold of the event. In other words, the features of the motion sensing signal which exceed the threshold will trigger the event. The event threshold can be defined as a constant according to an experimental rule or a constant where a root mean square (RMS) of the sensing value is multiplied by a specific factor. For example, the event threshold of the accelerometer can use ±0.5 g or ±0.5 rms. The following Equation (1) is an RMS calculation:

$$rms = \sqrt{\frac{{\sum }_{i = 1}^{n} {x}_{i}^{2}}{n}} , \qquad ( 1 )$$

wherein xᵢ is a value of the ith sampling point among the n data sampling points. The event represents the trigger conditions of triggering the event. In this embodiment, in order to extract features of the motion sensing signal from the motion sensing signal record 52, the slope variation of the sensing value data can be used to be the event feature. For example, the slope changes from positive to 0 (Positive→0) or changes from negative to 0 (Negative→0). The operation represents an operation performed when the feature of the motion sensing signal confirms that the trigger conditions have occurred. The result of the operation will become a part of the random seed 98. It is noteworthy that, in this embodiment, because the rotation angular velocity along each axis of the track 81 of the device 10 for generation of a secret key does not exceed the event threshold ±180, no event of the rotation angular velocity along each axis is triggered.

Table 2 is a bit operation look-up table according to another embodiment of the present disclosure.

TABLE 2

| | Input | | | Event | Opera- |
|---|---|---|---|---|---|
| Priority | axis | Unit | Event threshold | (Slope) | tion |
| 1 | aₓ | g | F1 threshold = F1ₜ | (F1[i] > F1ₜ) & | OPaₓ |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |
| 2 | a_{y} | g | F1 threshold = F1ₜ | (F1[i] > F1ₜ) & | OPa_{y} |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |
| 3 | a_{z} | g | F1 threshold = F1ₜ | (F1[i] > F1ₜ) & | OPa_{z} |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |
| 4 | Ωₓ | deg/s | F1 threshold = F1ₜ | (F1[i] > F1ₜ) & | OPΩₓ |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |
| 5 | Ω_{y} | deg/s | F1 threshold = F1ₜ | (F1[i] > F1ₜ) & | OPΩ_{y} |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |
| 6 | Ω_{z} | deg/s | F1 threshold = F1ₜ | (F1[i] > F1ₜ) & | OPΩ_{z} |
| | | | F2 threshold = F2ₜ | (F2[i] > F2ₜ) & | |
| | | | F3 threshold = F3ₜ | (F3[i] > F3ₜ) & | |
| | | | F4 threshold = F4ₜ | (F4[i] > F4ₜ) | |

As shown in Table 2, the event represents the trigger conditions of triggering the event. In order to extract the features of the motion sensing signal from the motion sensing signal record 52, the Equation (2) can be used to extract the four features F1˜F4. Equation (2) is as follows:

$$W [ i ] = \frac{( {\sum }_{j = 0}^{ws} \vert S [ ws \times i + j ] \vert )}{ws} , i = 0 , 1 , … , N / ws , \qquad ( 2 )$$

wherein W[i] is the acceleration of the ith window, S[j] is the acceleration value of the jth data point, and ws (window size) is the window size. According to Equation (2), the four features F1˜F4 can be obtained as follows:

Feature 1 (F1): the average acceleration of the four windows.

F1[i]=(Σⱼ₌₀³[i−j])/4, i=3, 4, . . . , N/ws. (3)

Feature 2 (F2): the difference between the sequential windows. A[i] is defined as an average of the first order derivative S[j],

A[i]=(Σⱼ₌₁^{ws}(S[ws×i+j −S[ws×i+j−1]))/ws, i=0,1, . . . , N/ws. (4)

F2[i]=Σⱼ₌₀³(A[i−j]−A[i−j−1]), i=0,1, . . . , N/ws. (5)

Feature 3 (F3): the variation of the window signal intensity.

F3[i](Σⱼ₌₀³(F1[i−j]−F1∂i−j−1])/4, i=4, 5, . . . , N/ws. (6)

Feature 4 (F4): the distance between the window signals.

F4[i]=Max(S[ws×i+j])−Min(S[ws×i+j]), i=0, 1, . . . , N/ws, (7)

wherein the window size ws can be a fixed size or can be adjusted dynamically according to the demand of the user. OPaₓ˜OPΩ_{z} in the operation field represent the operations performed when the trigger conditions of the events along each axis are held. The result of the operations will become a part of the random seed 98.

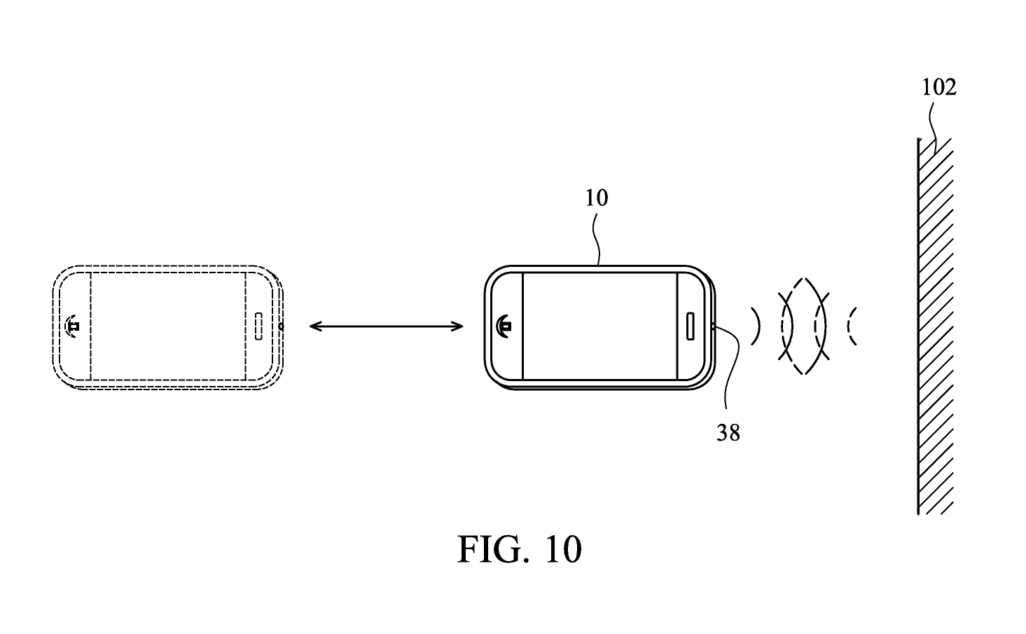

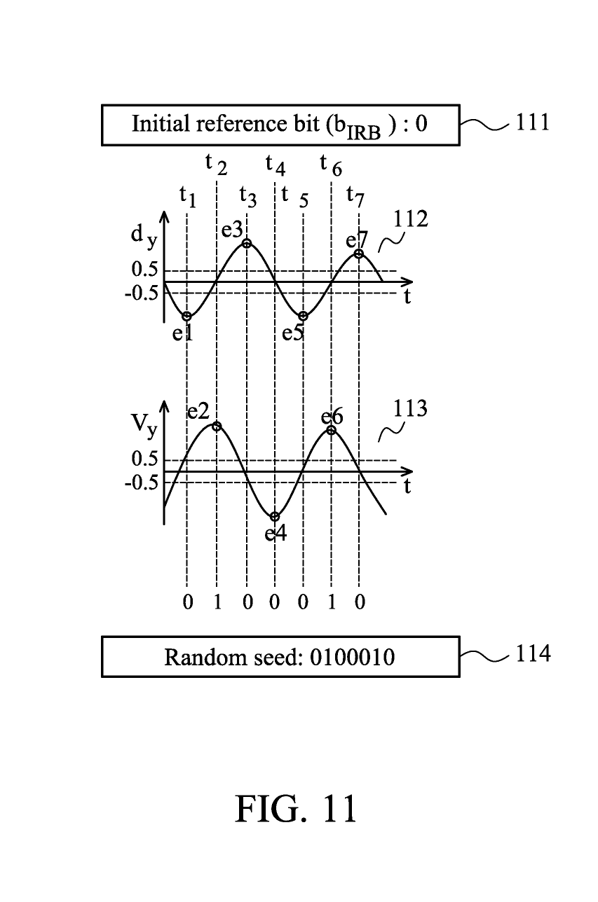

FIG. 10 is a motion schematic diagram according to another embodiment of the present disclosure. FIG. 11 is a schematic diagram illustrating how the random seed is generated according to another embodiment of the present disclosure. Table 3 is a bit operation look-up table according to another embodiment of the present disclosure.

TABLE 3

| | Input | | | Event | Opera- |
|---|---|---|---|---|---|
| Priority | axis | Unit | Event threshold | (Slope) | tion |
| 1 | d_{y} | m | ±0.5 rms | Positive → 0 | [symbol] bᵢ₋₁ |
| | | | | Negative → 0 | bᵢ₋₁ |
| 2 | v_{y} | m/s | ±0.5 rms | Positive → 0 | [symbol] bᵢ₋₁ |
| | | | | Negative → 0 | bᵢ₋₁ |

As shown in FIG. 10 and FIG. 11, the user operates the device 10 for generation of a secret key to sense a motion. The device 10 for generation of a secret key has a sonar 38. The user performs a motion in front of a wall 102 at a suitable angle. The sonar 38 can position a distance (dₓ) between the device 10 for generation of a secret key and the wall 102 according to a velocity of sound propagation in the air. In addition, the sonar 38 also can detect the relative velocity (vₓ) between the device 10 for generation of a secret key and the wall 102 according to the Doppler Effect. The curve diagrams 112˜113 are the diagrams generated after pre-processing the motion sensing signal record 52. There are events e₁˜e₇ triggered at the time points t₁˜t₇ according to the priority, the input axis, the unit, the event threshold and the event defined in Table 3. Finally, the random seed (b₀˜b₆: 010001014 can be generated according to the operations defined in Table 3 and initial reference bit (b_{IR}=0) 111. For example, the slope of the X-axis acceleration of the event e₁ changes from negative to 0 (Negative→0), and the operation of b₀ is equal to the last bit (bᵢ₋₁) according to Table 3. Because there is no information before the bit b₀, the initial reference bit (b_{RB}=0) 111 is used to generate b₀=0. The rest of the bits b₁˜b₆ may be deduced by analogy.

Please refer to Table 3, the bit operation look-up table includes the fields to indicate the priority, the input axis, the unit, the event threshold, the event, and the operation. The priority represents an order of the priority for generating the bits of the random seed when the events of different axes are triggered at the same time. The input axis represents the type of the input axis. For example, d_{y} represents the translation distance along the Y-axis, and v_{y} represents the translation velocity along the Y-axis. The unit represents the unit of the sensing value. For example, the sensing value unit of the sonar can use meters “m” or meters per second (m/s). The event threshold represents the threshold of the event. In other words, the features of the motion sensing signal which exceed the threshold will trigger the event. The event threshold can be defined as a constant according to an experimental rule or a constant where a root mean square (RMS) of the sensing value is multiplied by a specific factor (Please refer to Equation (1)). The event represents the trigger conditions of triggering the event. In this embodiment, in order to extract the features of the motion sensing signal from the motion sensing signal record 52, the slope variation of the sensing value data can be used to be the event feature. For example, the slope changes from positive to 0 (Positive→0) or changes from negative to 0 (Negative→0). The operation represents an operation performed when the feature of the motion sensing signal confirms that the trigger conditions have occurred. The result of the operation will become a part of the random seed 114.

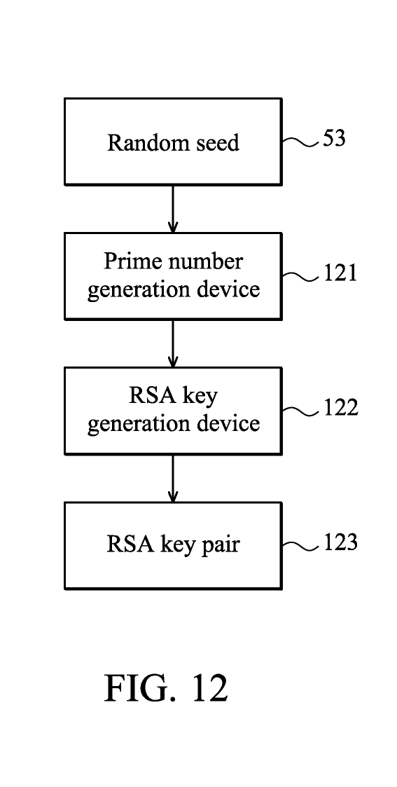

FIG. 12 is a schematic diagram illustrating the random seed generating an asymmetric key pair according to an embodiment of the present disclosure. As shown in FIG. 12, the random seed 53 also can be used to generate an asymmetric key pair, for example but not limited to the RSA key pair. The prime number generation device 121 generates two large prime numbers in accordance with the random seed 53. Then, the RSA key generation device 122 calculates the RSA key pair 123 in accordance with the two large prime numbers.

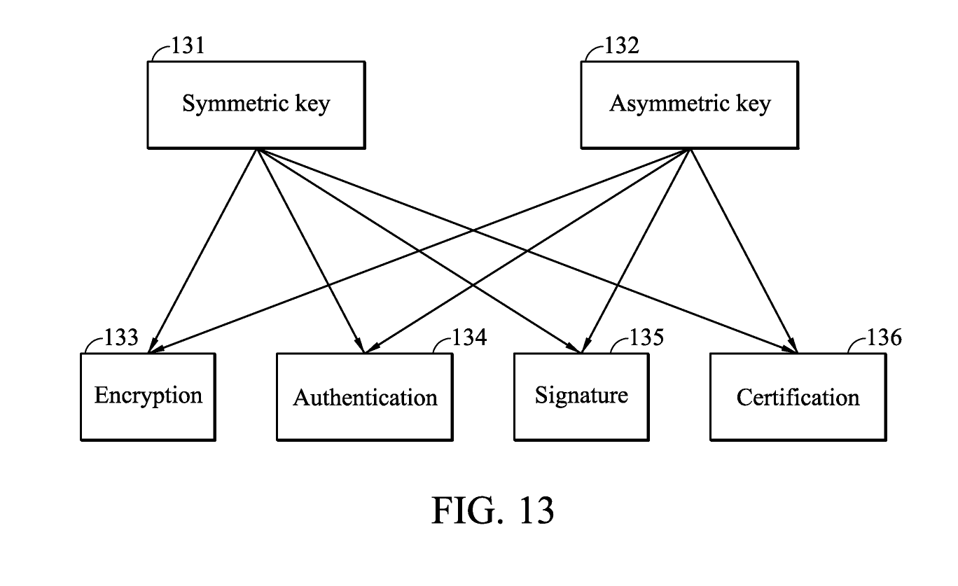

FIG. 13 is a schematic diagram illustrating how the secret key is used according to an embodiment of the present disclosure. As shown in FIG. 13, the symmetric key 131 and the asymmetric key 132 generated by the device 10 for generation of a secret key can be used to provide encryption 133, authentication 134, signature 135 and certification 136, and so on.

It must be noted that, the control unit, the input interface, the output interface, the storage unit, the motion sensor and the communication interface described above are the individual components in the device 10 for generation of a secret key. However, these components can be integrated together to reduce the numbers of the components in the device.

Therefore, the user can use the method and device in the disclosure for generation of a secret key and the information sensed by each sensing component to transfer the motion features operated by the user to the secret key. The user can regenerate the same secret key by performing the same motion. This can prevent inconvenience where the user has to carry another memory device to store the secret key. In addition, it can also avoid the noise interference from the environment when the device generates the key and improve the recognition rate of the motion sensing signal.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for generation of a secret key, comprising
a motion sensor, configured to sense a motion of the device in a three-dimensional space and generate a motion sensing signal;
a storage unit, configured to store the motion sensing signal; and
a control unit, electrically coupled to the motion sensor and the storage unit, and configured to generate a secret key by the motion sensing signal.

2. The device for generation of a secret key as claimed in claim 1, further comprising:
an input interface, electrically coupled to the control unit, and configured to receive an instruction inputted by a user to start or stop sensing the motion of the device by the motion sensor;
an output interface, electrically coupled to the control unit, and configured to output the secret key generated by the control unit; and
a communication interface, electrically coupled to the control unit, and configured to transmit the secret key to a remote device.

3. The device for generation of a secret key as claimed in claim 1, wherein the motion sensor comprises:
an X-axis accelerometer, configured to measure an X-axis acceleration of the device along the X-axis in the three-dimensional Cartesian coordinates;
a Y-axis accelerometer, configured to measure a Y-axis acceleration of the device along the Y-axis in the three-dimensional Cartesian coordinates;
a Z-axis accelerometer, configured to measure a Z-axis acceleration of the device along the Z-axis in the three-dimensional Cartesian coordinates;
a pitch gyroscope, configured to measure a pitch angular velocity of the device along the X-axis in the three-dimensional Cartesian coordinates;
a roll gyroscope, configured to measure a roll angular velocity of the device along the Y-axis in the three-dimensional Cartesian coordinates; and
a yaw gyroscope, configured to measure a yaw angular velocity of the device along the Z-axis in the three-dimensional Cartesian coordinates.

4. The device for generation of a secret key as claimed in claim 1, wherein the motion sensor comprises:
a camera, configured to measure a relative motion between the device and surrounding objects or reference images, and calculate a speed or an acceleration of N degrees of freedom of the device in the three-dimensional Cartesian coordinates, wherein N is a natural number which is greater than or equal to 1 and smaller than or equal to 6.

5. The device for generation of a secret key as claimed in claim 1, wherein the motion sensor comprises:
a sonar, configured to measure a relative motion between the device and surrounding objects or reference points, and calculating a speed or an acceleration of N degrees of freedom of the device in the three-dimensional Cartesian coordinates, wherein N is a natural number which is greater than or equal to 1 and smaller than or equal to 6.

6. The device for generation of a secret key as claimed in claim 1, wherein the control unit further performs the steps as follows:
searching features of the motion sensing signal according to a bit operation look-up table to generate a bit stream;
attaching the bit stream to a random seed; and
using the random seed in a one-way function calculation to generate the secret key,
wherein the motion sensing signal is a sensing data of N input axes corresponding to time, and N is a natural number which is greater than or equal to 1 and smaller than or equal to 6.

7. The device for generation of a secret key as claimed in claim 6, wherein the motion sensing signal is processed by a DC remove and a curve smoother.

8. The device for generation of a secret key as claimed in claim 6, wherein the random seed consists of N bits, and N is a natural number which is greater than 0.

9. The device for generation of a secret key as claimed in claim 6, wherein a first bit of the random seed is derived according to a predetermined initial reference bit.

10. The device for generation of a secret key as claimed in claim 6, wherein the secret key generated by the control unit via the one-way function calculation is a specific-length bit stream.

11. The device for generation of a secret key as claimed in claim 6, wherein the secret key consists of N bits, and N is a natural number which is greater than 0.

12. The device for generation of a secret key as claimed in claim 2, wherein the communication interface uses wired and wireless communications technology.

13. The device for generation of a secret key as claimed in claim 1, wherein the device is a hand-held mobile device.

14. A method for generation of a secret key, comprising
sensing, by a motion sensor, a motion of a device in a three-dimensional space and generating a motion sensing signal;
storing, by a storage unit, the motion sensing signal; and
generating, by a control unit, a secret key by transferring the motion sensing signal.

15. The method for generation of a secret key as claimed in claim 14, further comprising:
receiving, by an input interface, an instruction inputted by a user to start or stop sensing the motion of the device by the motion sensor;
outputting, by an output interface, the secret key generated by the control unit; and
transmitting, by a communication interface, the secret key to a remote device.

16. The method for generation of a secret key as claimed in claim 14, wherein the motion sensor further comprises an X-axis accelerometer, a Y-axis accelerometer, a Z-axis accelerometer, a pitch gyroscope, a roll gyroscope and a yaw gyroscope, the method further comprising:
measuring, by the X-axis accelerometer, an X-axis acceleration of the device along the X-axis in the three-dimensional Cartesian coordinates;
measuring, by the Y-axis accelerometer, a Y-axis acceleration of the device along the Y-axis in the three-dimensional Cartesian coordinates;
measuring, by the Z-axis accelerometer, a Z-axis acceleration of the device along the Z-axis in the three-dimensional Cartesian coordinates;
measuring, by the pitch gyroscope, a pitch angular velocity of the device along the X-axis in the three-dimensional Cartesian coordinates;
measuring, by the roll gyroscope, a roll angular velocity of the device along the Y-axis in the three-dimensional Cartesian coordinates; and
measuring, by the yaw gyroscope, a yaw angular velocity of the device along the Z-axis in the three-dimensional Cartesian coordinates.

17. The method for generation of a secret key as claimed in claim 14, wherein the motion sensor further comprises a camera, the method further comprising:
measuring, by the camera, a relative motion between the device and surrounding objects or reference images, and calculating a speed or an acceleration of N degrees of freedom of the device in the three-dimensional Cartesian coordinates, wherein N is a natural number which is greater than or equal to 1 and smaller than or equal to 6.

18. The method for generation of a secret key as claimed in claim 14, wherein the motion sensor further comprises a sonar, the method further comprising:
measuring, by the sonar, a relative motion between the device and surrounding objects or reference points, and calculating a speed or an acceleration of N degrees of freedom of the device in the three-dimensional Cartesian coordinates, wherein N is a natural number which is greater than or equal to 1 and smaller than or equal to 6.

19. The method for generation of a secret key as claimed in claim 14, further comprising:
searching, by the control unit, features of the motion sensing signal according to a bit operation look-up table to generate a bit stream;
attaching, by the control unit, the bit stream to a random seed; and
using, by the control unit, the random seed to a one-way function calculation to generate the secret key,
wherein the motion sensing signal is a sensing data of N input axes corresponding to time, and N is a natural number which is greater than or equal to 1 and smaller than or equal to 6.

20. The method for generation of a secret key as claimed in claim 19, further comprising:
processing, by the control unit, the motion sensing signal via a DC remove and a curve smoother.

21. The method for generation of a secret key as claimed in claim 19, wherein the random seed consists of N bits, and N is a natural number which is greater than 0.

22. The method for generation of a secret key as claimed in claim 19, wherein a first bit of the random seed is derived according to a predetermined initial reference bit.

23. The method for generation of a secret key as claimed in claim 19, wherein the secret key generated by the control unit via the one-way function calculation is a specific-length bit stream.

24. The method for generation of a secret key as claimed in claim 19, wherein the secret key consists of N bits, and N is a natural number which is greater than 0.

25. The method for generation of a secret key as claimed in claim 15, wherein the communication interface uses wired and wireless communications technology.

26. The method for generation of a secret key as claimed in claim 14, wherein the device is a hand-held mobile device.
